(19) United States
(12) Patent Application Publication
(10) Pub. No.: US 2013/0343230 A1
(43) Pub. Date: Dec. 26, 2013

(54) Eliminating long distance charge at long distance and international calling

(71) Applicant: Power2Mobility, Toronto (CA)

(72) Inventors: Konstantin Manyakin, Toronto (CA); Adiel Rozinov, Richmond Hill (CA)

(73) Assignee: Power2Mobility, Toronto (CA)

(21) Appl. No.: 13/705,128

(22) Filed: Dec. 4, 2012

Related U.S. Application Data
(60) Provisional application No. 61/568,153, filed on Dec. 8, 2011.

(51) Int. Cl. H04W 4/16

(52) U.S. Cl. CPC H04W 4/16
USPC 370/259

(57) ABSTRACT

A method and system for eliminating long distance charge by answering incoming call through local number pick up employs a mobile phone equipped with application client which intercepts call attempt and traverses (anchors the call) telephony server of provider that serves destination subscribers. Such anchoring can be achieved by variety of techniques including (but not limited to) using local access numbers or dedicated customer's DIDs, calls through VOIP, iNum or by using ENUM.

Telephony server will send notifications to destination device by using push notification, SMS or another mechanism. This notification will prompt user regarding incoming call and upon user acceptance, call will be placed to local number served by provider.

Telephony server will connect both parties and as a result call is established without having any additional ‘long distance’ charges involved. All call establishment steps will be done seamlessly from the prospective of the user.

### CROSS-REFERENCE TO RELATED APPLICATIONS

This application claims the benefit of Applicants' prior provisional application, number [61/568,153], filed on [Dec. 8, 2011].

### MICROFICHE APPENDIX

Not Applicable.

### TECHNICAL FIELD OF INVENTION

This application relates in general to providing of communications services and, in particular, to a method and system for eliminating long distance charge at long distance and international calling for incoming anchored cellular calls.

### BACKGROUND OF THE INVENTION

In the context of mobile network when user receives the call while he/she is outside of his/her home network corresponding long distance charges will be applied. If this incoming call has been delivered to the customer mobile phone through the VOIP operator infrastructure (for example through personal DID) it is necessary to provide an effective way to eliminate these long distance charges for these customers. At the same time we can rely on fact that in Cellular network the call placed from the terminal that outside home network to local number will not be a subject of long distance tariff.

Known methods of minimizing long distance charges for incoming calls have different drawbacks. For example, delivering an incoming call as IP call over data network (WiFi/3G/4G) can be problematic because of absence of data connection, not sufficient quality of data connection, using data plan that does not allow VOIP, other restrictions enforced by the carrier (blocking VOIP traffic) or regulation restrictions. Even when VOIP calling might be possible, device could be not properly equipped for making VOIP calls.

There therefore exists a need for a method and system that provides an effective way of accepting incoming anchored calls that can eliminate long distance charges.

There therefore exists a need for service providers to enable a method and system that can establish a call to their customers by answering incoming anchored call through local number pick up call and therefore eliminating long distance charge at long distance and international calling.

### BRIEF SUMMARY OF THE INVENTION

It is therefore an object of the invention to provide a method and a system for eliminating long distance charge at long distance and international calling by answering incoming anchored call through local number pick up.

The invention therefore provides a method for eliminating long distance charge at long distance and international calling by answering incoming anchored call through local number pick up comprising: receiving initial incoming call anchored by different means and traversing this call to the call control application server (CCAS); keeping this initial call request by CCAS; sending notification to destination device by using push notification, SMS or another mechanism; prompting user regarding incoming call; upon user acceptance placing a call to local number (pickup number or pickup DN) served by provider; receiving the call request through this pickup DN by the call control application server (CCAS) which keeping the initial anchored call; and completing the connection between a call to the called pickup number and initial incoming call by CCAS which correlates initial incoming call with the call to the pickup DN.

The invention further provides a system for eliminating long distance charge at long distance and international calling by answering incoming anchored call through local number pick up, comprising: a mobile phone equipped with application client programmed to: monitor for notifications from the server about incoming calls; make a call to the certain local number (pickup number or pickup DN); and a call control application server (CCAS), comprising a service programmed to: receive initial incoming call anchored by different means; keep (park) this initial call request and notify user's mobile phone about incoming call; wait for incoming call from the subscriber mobile phone through certain call pickup number; receive the call request through this pickup DN; correlate initial incoming call with the call to the pickup DN and complete the connection between them.

The invention further provides a mobile handset application client, comprising: program instructions to monitor notification from the server about incoming calls; and program instructions for receiving parameters of pickup call (pickup number, DTMF sequence) within notification message sent by server; and program instructions for launching a cellular telephone call from the mobile cellular handset using certain pick up DN and optionally sending DTMF sequence right after pickup call is answered by the server.

The invention yet further provides a call control application server, comprising: a service application that is receiving anchored called; instead of sending call to the device sending notification to the device by using push notification, SMS or another mechanism; keeping (parking) this initial received incoming call request while waiting for incoming call pick up from the subscriber phone; identifies incoming call by one of or combination of dedicated pickup number per subscriber, CallerID that is matching subscriber phone or/and DTMF combination that is sent by subscriber right after pickup call is answered by the server; completes the call setup request to connect the subscriber to the initial incoming call.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIG. 2 provides an exemplary communication flow according to the embodiment of the disclosure which used short messaging as notification mechanism and call anchored through dialing to access numbers DN

FIG. 3 provides an exemplary communication flow according to the embodiment of the disclosure which used push messaging as notification mechanism and call anchored as VOIP call.

FIG. 4 provides an exemplary communication flow according to the embodiment of the disclosure which used short messaging as notification mechanism and call anchored through dialing to INUM Gateway access numbers DN

FIG. 5 is a block representation of a mobile handset with an application client according to one embodiment of the disclosure.

FIG. 6 is a block representation of a call control application server according to one embodiment of the disclosure.

### DETAILED DESCRIPTION OF THE PREFERRED EMBODIMENT

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

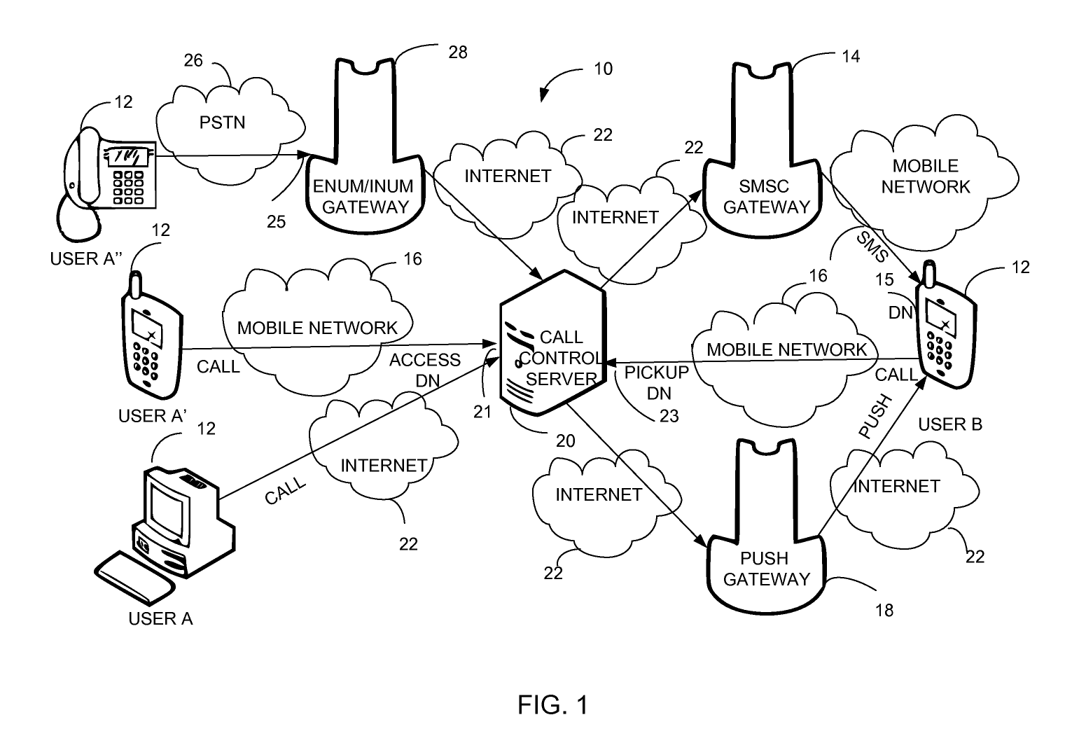

Prior to delving into the details of select embodiments, an overview of an exemplary communication environment 10 is provided in association with FIG. 1. In general, a call control application server (CCAS) 20 is provided to facilitate call establishment between two phones and to connect incoming call anchored through user's personal or provider access DID 21, using VOIP system of the service provider, through INUM number or ENUM 25, by calling to local pick up number 23. The call control application server (CCAS) 20 that is receiving anchored called will send notification to the device by using push notification, SMS or another mechanism through SMSC gateway 14, push gateway 18 or others. In an exemplary embodiment, the mobile handset 12 is equipped with application client whom monitors incoming notifications that contain parameters of pickup call (pickup number, DTMF sequence sent by server by SMS or through push notification or by using request to the server prior to initiating of pickup call). After receiving this call pickup information through SMS or push notification the mobile phone of user B 12 will make a call to specified local pickup number 23 and send (optionally) DTMF sequence. After receiving the call request through this local pickup DN 23 the call control application server (CCAS) 20 will correlate the initial incoming anchored call with the call to the pickup DN 23 and complete the connection between a call to the called pickup number 23 and initial incoming call kept by CCAS 20.

Notably, the devices 12 for user A, A′ or A″ may take virtually any form, including wired or wireless telephones, personal computers with VOIP application, and the like. The labels provided for these terminals in this description and the following claims are used only to improve readability and separately identify the terminals.

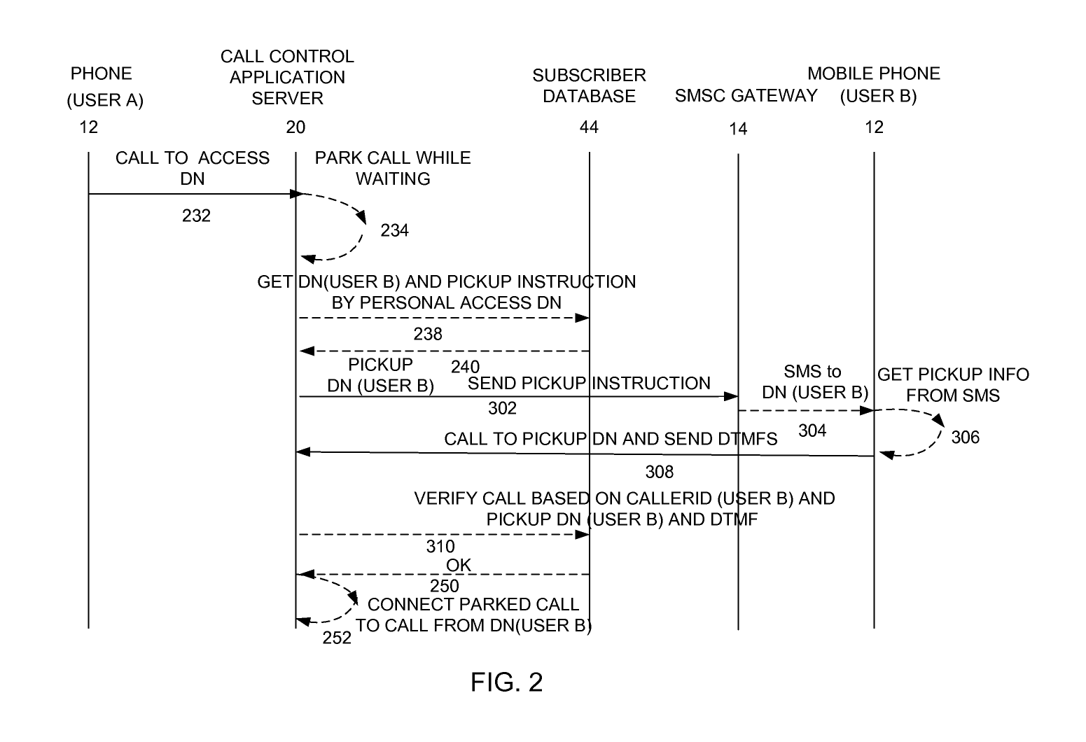

With reference to FIG. 2, a communication flow is provided to illustrate an exemplary scenario for utilizing the call control application server 20 to set up a voice call between user A and user B equipped with application client 30. This is only an exemplary scenario of voice call establishment between two phones, which anchored through calling personal DID 21, and the aspects and elements represented in the communication flow are not all deemed necessary for implementation of the present invention. Personal DID 21 could be replaced with provider's access DN and the destination DN can be send through DTMF, but this scenario is not described in this embodiment. For purposes of clarity, the phone 12 of user A associated with DN A is labelled “Phone (user A) 12”. Likewise the mobile handset 12 of user B associated with DN B is labelled “Mobile Phone (user B) 12”. The call control application server 20 operates to accept incoming call from users through personal access DN (personal DID). The subscriber database 44 operates to store user profile information and to provide this information to the service application 40 as requested. In exemplary embodiments, the user database 44 may form a part of the call control application server 20.

At some point, the user A decides to initiate a call from the phone (user A) 12 to the phone (user B) 12 using certain access DN (personal DID) 21 (step 232).

The call control application server (CCAS) 20 is receiving an inbound call request at the access DN 21 (step 232), extracting the calling number (user A's DN) and parking the call (step 234).

Now in possession of user B's personal access DN the call control application server (CCAS) 20 matches it with information in subscriber's database 44 (step 238) and retrieves the called number (user B's DN 15) and necessary pick up information (call pickup number and DTMF sequence) to formulate an assisting SMS with given pick up instructions (step 302).

This information will be sent to the SMSC gateway 14 through corresponding communication interface (step 302). In exemplary scenario RESTful API 22 is used as such interface but it can be any type of inter services connectivity.

Next, the SMS gateway 14 sends assisting SMS (SMSAM) message to user B's DN 15 (step 304) as originated from user B's personal access DN 21.

The application client 30 in phone (user B) 12 will intercept this incoming assisting SMS message, identify that it is a message from the call control application server (CCAS) 20 and extract pick up information (step 306) (call pickup number DN 23 and DTMF sequence). At the same time the application client will initiate a cellular telephone call from the mobile cellular handset using received pickup DN 23 (step 308) and send correspondent DTMF sequence to the call control application server (CCAS) 20.

The call control application server (CCAS) 20 is receiving an inbound call request at the pickup DN 23 (step 308) and extracting the calling number (user B's DN) and sent DTMF sequence.

Now in possession of user B's DN, DTMF sequence and user's B pickup DN the call control application server (CCAS) 20 matches it with information in subscriber's database 44 (step 310) and retrieves the initial parked call leg (step 250).

Now the call control application server (CCAS) 20 connects the initial parked call leg and incoming call to pick up DN 23 and connects the subscriber to the called number (step 252).

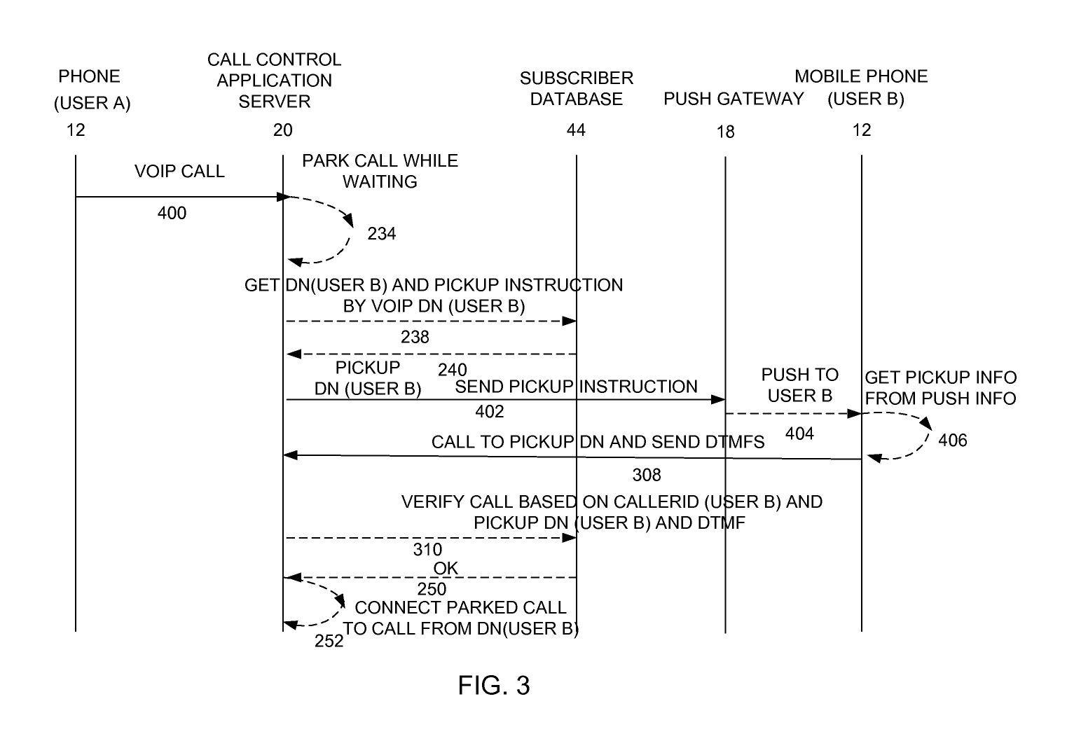

With reference to FIG. 3, a communication flow is provided to illustrate an exemplary scenario for utilizing the call control application server 20 to set up a voice call between user A and user B equipped with application client 30. This is only an exemplary scenario of voice call establishment between two phones, which anchored using VOIP system of the service provider where the call control application server (CCAS) 20 is using push messaging as notification mechanism to provide call pickup information to user's B handset equipped with the application client 30.

The call control application server (CCAS) 20 is receiving an inbound VOIP call request (step 400), extracting the calling number (user A's DN) and called VOIP number for user B (which is not necessary is user B mobile DN) and parking the call (step 234).

Now in possession of user VOIP B's DN the call control application server (CCAS) 20 matches it with information in subscriber's database 44 (step 238), retrieve user B's mobile DN and necessary pick up information (call pickup number and DTMF sequence) to formulate an assisting push message with given pick up instructions (step 402).

This information will be sent to the push gateway 18 through corresponding communication interface (step 402). In exemplary scenario RESTful API 22 is used as such interface but it can be any type of inter services connectivity.

Next, the push gateway 18 sends assisting push message to user B's DN 15 (step 404).

The application client 30 in phone (user B) 12 will receive this push message, identify that it is a message from the call control application server (CCAS) 20 and extract pick up information (step 406) (call pickup number DN 23 and DTMF sequence). At the same time the application client will initiate a cellular telephone call from the mobile cellular handset using received pickup DN 23 (step 308) and send correspondent DTMF sequence to the call control application server (CCAS) 20.

The call control application server (CCAS) 20 is receiving an inbound call request at the pickup DN 23 (step 408) and extracting the calling number (user B's DN) and sent DTMF sequence.

Now in possession of user B's DN, DTMF sequence and user's B pickup DN the call control application server (CCAS) 20 matches it with information in subscriber's database 44 (step 310) and retrieves the initial parked call leg (step 250).

Now the call control application server (CCAS) 20 connects the initial parked VOIP call leg and incoming call to pick up DN 23 and connects the subscriber to the called number (step 252).

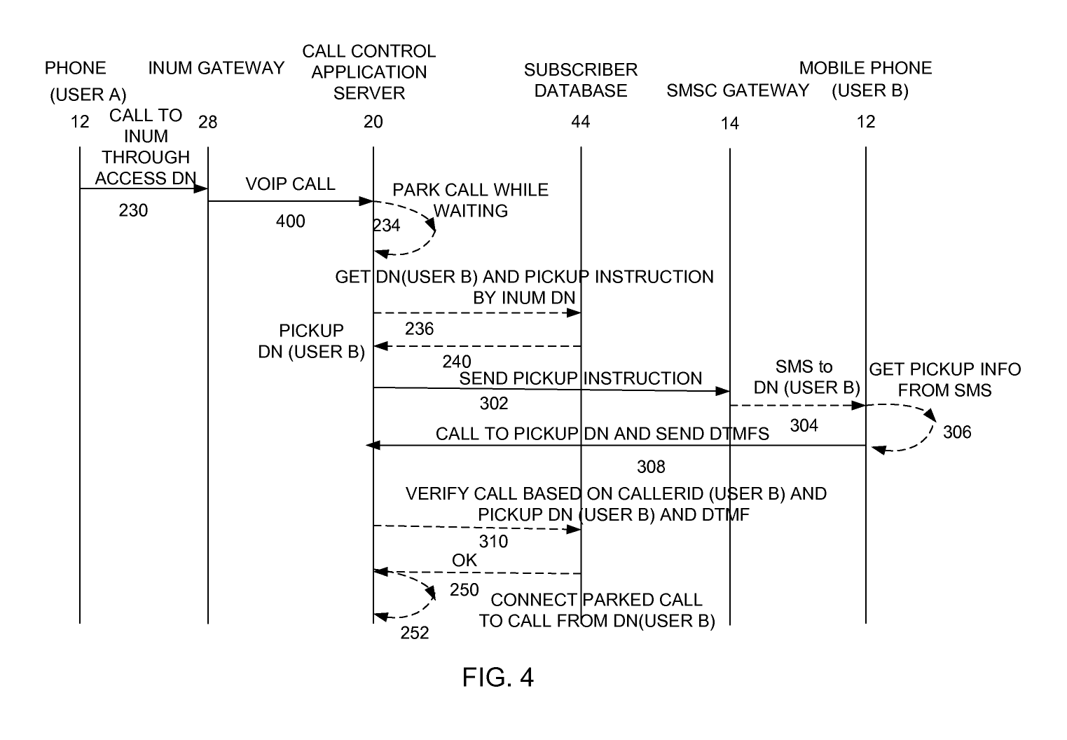

With reference to FIG. 4, a communication flow is provided to illustrate an exemplary scenario for utilizing the call control application server 20 to set up a voice call between user A and user B equipped with application client 30. This is only an exemplary scenario of voice call establishment between two phones, which anchored using INUM by calling through access DN 25 of INUM gateway 28 where the call control application server (CCAS) 20 is using SMS messaging as notification mechanism to provide call pickup information to user's B handset equipped with the application client 30.

At some point, the user A decides to initiate a call from the phone (user A) 12 to the phone (user B) 12 using certain it's INUM and through specific access DN 25 of INUM gateway 28 (step 230). INUM gateway will accept this call and convert it to VOIP call based on INUM passed by DTMF (step 400).

The call control application server (CCAS) 20 is receiving an inbound VOIP call request, extracting the calling number (user A's DN) and called INUM number for user B and parking the call (step 234).

Now in possession of user B's INUM the call control application server (CCAS) 20 matches it with information in subscriber's database 44 (step 236) and retrieves the called number (user B's DN 15) and necessary pick up information (call pickup number and DTMF sequence) to formulate an assisting SMS with given pick up instructions (step 302).

This information will be sent to the SMSC gateway 14 through corresponding communication interface (step 302). In exemplary scenario RESTful API 22 is used as such interface but it can be any type of inter services connectivity.

Next, the SMS gateway 14 sends assisting SMS (SMSAM) message to user B's DN 15 (step 304) as originated from user B's INUM.

The application client 30 in phone (user B) 12 will intercept this incoming assisting SMS message, identify that it is a message from the call control application server (CCAS) 20 and extract pick up information (step 306) (call pickup number DN 23 and DTMF sequence). At the same time the application client will initiate a cellular telephone call from the mobile cellular handset using received pickup DN 23 (step 308) and send correspondent DTMF sequence to the call control application server (CCAS) 20.

The call control application server (CCAS) 20 is receiving an inbound call request at the pickup DN 23 (step 308) and extracting the calling number (user B's DN) and sent DTMF sequence.

Now in possession of user B's DN, DTMF sequence and user's B pickup DN the call control application server (CCAS) 20 matches it with information in subscriber's database 44 (step 310) and retrieves the initial parked call leg (step 250).

Now the call control application server (CCAS) 20 connects the initial parked call leg and incoming call to pick up DN 23 and connects the subscriber to the called number (step 252).

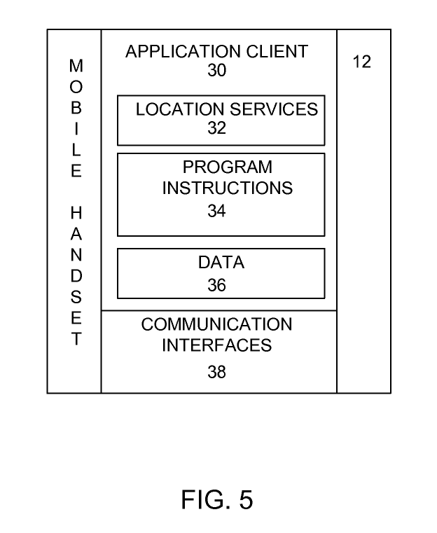

With reference to FIG. 5, a block representation of the mobile handset (smartphone) 12 with an application client 30 is illustrated according to one embodiment. The mobile handset 12 includes an application client 30 having capability of gathering location information from location services 32 and program instructions 34 and data 36 to operate as described above. The program instructions 34 provide the communication functions, data storage and gathering functions and geo location function which are described above. The application client 30 can interact with three communication interfaces 38 (SMS, push notification and call setup through mobile network) to gather additional information through SMS assisting message or push message and to establish a call through pick up DN 23 as illustrated in the communication environment 10.

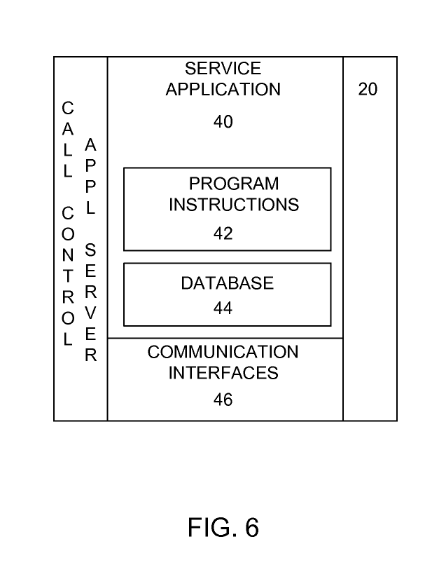

With reference to FIG. 6, a block representation of a call control application server 20 is illustrated. The call control application server 20 includes a service application 40 having capability to store and retrieve subscriber and call specific data in database 44 and program instructions 42 for initiating SMS assisting message or push notification, accepting and control call requests to access DN 21 or to VOIP trunk and to pick up DN 23 and processing DTMF sequences as described above. The service application 40 interacts with through several communication interfaces 48 with SMS gateways, push gateway, INUM/ENUM gateways, PSTN and mobile network to provide call control functionality as described above.

Those skilled in the art will recognize improvements and modifications to the embodiments of the present invention. All such improvements and modifications are considered within the scope of the concepts disclosed herein and the claims that follow.

1. A method for eliminating long distance charge at long distance and international calling by answering incoming anchored call through local number pick up comprising: receiving by the call control application server (CCAS) initial incoming call anchored by following (but not limited to) techniques by placing a call:
by using local access number service provided by the service provider
through dedicated DID that belong to destination customer
through VOIP system of the service provider
through INUM number
by using ENUM;
keeping this initial call request by CCAS; sending notification to destination device by using push notification, SMS or another mechanism; prompting user regarding incoming call; upon user acceptance placing a call to local number (pickup number or pickup DN) served by provider;
receiving the call request through this pickup DN by the call control application server (CCAS) which keeping the initial anchored call; identifying incoming call by one of or combination of the following:
Dedicated pickup number per subscriber
CallerID that is matching subscriber phone
The server answers DTMF combination that is sent by subscriber right after pickup call;
and completing the connection between a call to the called pickup number and initial incoming call by CCAS.

2. The method as claimed in claim 1 wherein sending notification to the device comprises providing parameters of pickup call (pickup number, DTMF sequence) within notification message.

3. The method as claimed in claim 2 wherein receiving parameters of pickup call (pickup number, DTMF sequence) within notification message further comprises initiating call to the provided pickup DN and optionally with provided DTMF sequence by special application integrated with a native dialler.

4. The method as claimed in claim 1 further comprising: receiving pickup call request at the CCAS; identifying incoming call by one of or combination of dedicated pickup number per subscriber, CallerID that is matching subscriber phone or/and DTMF combination that is sent by subscriber right after pickup call is answered by the server; completing the connection between a call to the called pickup number and initial incoming call kept by CCAS.

5. A system for eliminating long distance charge at long distance and international calling by answering incoming anchored call through local number pick up, comprising: a mobile phone equipped with application client programmed to: monitor for notifications from the server about incoming calls; make a call to the certain local number (pickup number or pickup DN); and a call control application server (CCAS), comprising a service programmed to: receive initial incoming call anchored by different means; keep (park) this initial call request and notify user's mobile phone about incoming call; wait for incoming call from the subscriber mobile phone through certain call pickup number; receive the call request through this pickup DN; correlate initial incoming call with the call to the pickup DN and complete the connection between them.

6. A call control application server as claimed in claim 5 wherein receiving anchored called further comprises a service application which instead of sending call to the device sending notification to the device by using push notification, SMS or another mechanism.

7. A call control application server as claimed in claim 6 wherein sending notification to the device comprises a service application that providing parameters of pickup call (pickup number, DTMF sequence) within notification message.

8. The application client as claimed in claim 5 wherein receiving parameters of pickup call (pickup number, DTMF sequence) within notification message further comprises program instructions for initiating call to the provided pickup DN and optionally with provided DTMF sequence.

9. A call control application server, comprising: a service application that receives pickup call request; identifies incoming call by one of or combination of dedicated pickup number per subscriber, CallerID that is matching subscriber phone or/and DTMF combination that is sent by subscriber right after pickup call is answered by the server; completes the call setup request to connect the subscriber to the initial incoming call.
